(19) United States
(12) Patent Application Publication
(10) Pub. No.: US 2026/0255242 A1
(43) Pub. Date: Aug. 27, 2026

(54) METHOD OF MANAGING CELL GROUP CONNECTIVITY, USER EQUIPMENT, AND CHIP

(71) Applicant: GUANGDONG OPPO MOBILE TELECOMMUNICATIONS CORP., LTD., Dongguan (CN)

(72) Inventor: Xin YOU, Dongguan (CN)

(21) Appl. No.: 19/648,080

(22) Filed: Apr. 15, 2026

Related U.S. Application Data
(63) Continuation of application No. PCT/CN2024/131832, filed on Nov. 13, 2024.
(60) Provisional application No. 63/600,502, filed on Nov. 17, 2023.

(51) Int. Cl. H04W 36/08; H04W 36/00

(52) U.S. Cl. CPC H04W 36/08; H04W 36/0069

(57) ABSTRACT

A method of managing cell group connectivity performed by a user equipment (UE) includes determining to perform a multi-radio dual connectivity (MR-DC) release upon a trigger of a master cell group (MCG) lower-layer triggered mobility (LTM).

### CROSS-REFERENCE TO RELATED APPLICATION(S)

This application is a continuation of International Application No. PCT/CN2024/131832, filed November 13, 2024, which claims priority to U.S. Provisional Application No. 63/600,502, filed November 17, 2023, the entire disclosures of which are incorporated herein by reference.

### TECHNICAL FIELD

The present disclosure relates to the field of communication systems, and more particularly, to a method of managing cell group connectivity, a user equipment, and a chip.

### RELATED ART

In 3rd Generation Partnership Project (3GPP) Release 18 lower-layer triggered mobility (LTM), simultaneous changes of a primary cell (PCell) and a primary secondary cell (PSCell) are not supported. Future research may further explore efficient master cell group (MCG) switching without interrupting secondary cell group (SCG) connectivity, thereby improving network stability and flexibility in communication systems.

Therefore, there is a need for apparatuses and methods of managing cell group connectivity.

### SUMMARY

In a first aspect of the present disclosure, a method of managing cell group connectivity performed by a user equipment (UE) includes determining to perform a multi-radio dual connectivity (MR-DC) release upon a trigger of a master cell group (MCG) lower-layer triggered mobility (LTM).

In a second aspect of the present disclosure, a user equipment (UE) includes a memory storing a computer program and a processor coupled to the memory. When executed by the processor, the computer program causes the UE to perform the above method.

In a third aspect of the present disclosure, a chip includes a processor configured to call and run a computer program stored in a memory, to cause a device in which the chip is installed to execute the above method.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a block diagram of a UE according to an embodiment of the present disclosure.

FIG. 5 is a block diagram of a UE according to an embodiment of the present disclosure.

FIG. 6 is a flowchart illustrating a method of managing cell group connectivity performed by a UE according to an embodiment of the present disclosure.

FIG. 7 is a block diagram of an example of a computing device according to an embodiment of the present disclosure.

FIG. 8 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

For 3GPP Release 18 lower-layer triggered mobility (LTM) (or called layer 1/layer 2 (L1/L2)-triggered mobility), simultaneous changes to a primary cell (PCell) and a primary secondary cell (PSCell) are not supported. If a secondary cell group (SCG) configuration is present, it is released during a main cell group (MCG) LTM execution. A user equipment (UE) performs a multi-radio access technology (RAT) (MR)-dual connectivity (DC) release based on an explicit release indication (e.g., mrdc-SecondaryCellGroupConfig set to release) included in an LTM candidate cell configuration.

Since LTM candidate configurations are pre-configured by a network (NW), allowing subsequent LTM execution without reconfiguration, the explicit SCG release indication in the LTM candidate configuration may be invalid if the UE is in a DC mode. Additionally, releasing the SCG during the MCG LTM execution may impact a throughput of the UE. To mitigate this impact, future releases could explore enabling PCell changes without SCG release.

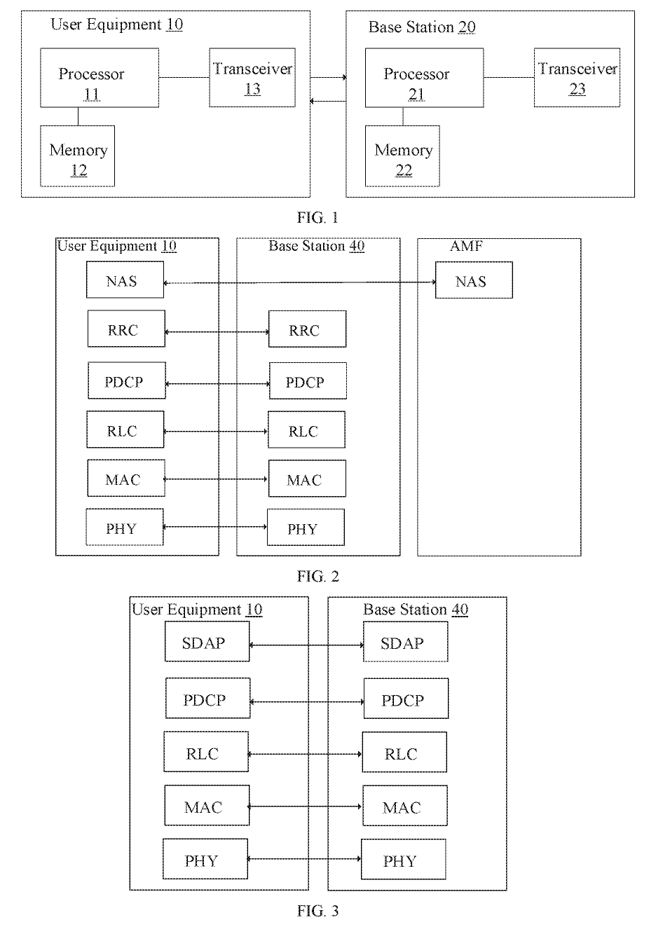

FIG. 1 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to determine to perform a multi-radio dual connectivity (MR-DC) release upon a trigger of a master cell group (MCG) lower-layer triggered mobility (LTM). This can solve issues in the prior art and other issues, manage cell group connectivity, and/or avoid a service interruption.

In some embodiments, the processor 21 is configured to transmit, to the UE 10, a trigger for a master cell group (MCG) lower-layer triggered mobility (LTM), wherein the trigger causes the UE 10 to determine whether to perform a multi-radio dual connectivity (MR-DC) release. This can solve issues in the prior art and other issues, manage cell group connectivity, and/or avoid a service interruption.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, the UE 10 is configured to determine to perform a multi-radio dual connectivity (MR-DC) release upon a trigger of a master cell group (MCG) lower-layer triggered mobility (LTM). This can solve issues in the prior art and other issues, manage cell group connectivity, and/or avoid a service interruption.

In some embodiments, the base station 40 is condigured to transmit, to the UE 10, a trigger for a master cell group (MCG) lower-layer triggered mobility (LTM), wherein the trigger causes the UE 10 to determine whether to perform a multi-radio dual connectivity (MR-DC) release. This can solve issues in the prior art and other issues, manage cell group connectivity, and/or avoid a service interruption.

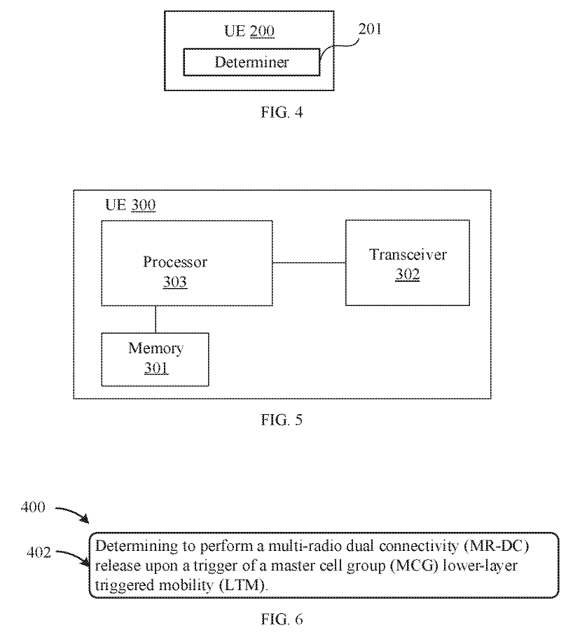

FIG. 4 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes a determiner 201 configured to determine to perform a multi-radio dual connectivity (MR-DC) release upon a trigger of a master cell group (MCG) lower-layer triggered mobility (LTM). This can solve issues in the prior art and other issues, manage cell group connectivity, and/or avoid a service interruption.

FIG. 5 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the processor 303 is configured to determine to perform a multi-radio dual connectivity (MR-DC) release upon a trigger of a master cell group (MCG) lower-layer triggered mobility (LTM). This can solve issues in the prior art and other issues, manage cell group connectivity, and/or avoid a service interruption.

In some embodiments, determining to perform the MR-DC release upon the trigger of the MCG LTM includes one or more of following operations: performing the MR-DC release upon the trigger of the MCG LTM based on a release indication, determining whether or not to perform the MR-DC release upon the trigger of the MCG LTM based on an indication included in an LTM cell switch command, determining whether or not to perform the MR-DC release or an MR-DC setup upon the trigger of the MCG LTM based on a cell group index and/or an availability of a secondary cell group (SCG) configuration, or autonomously performing the MR-DC release upon the trigger of the MCG LTM. In some embodiments, the release indication is included in an LTM candidate configuration.

In some embodiments, if the UE 10 is not in an MR-DC mode or the UE 10 has an MCG configuration without any associated secondary cell group (SCG) configuration, the release indication is ignored by the UE 10. In some embodiments, the cell group index is associated with a source cell and a target cell, and/or the availability of the SCG configuration associated with the target cell. In some embodiments, if the UE 10 is in an MR-DC mode, and the release indication is not included in a target cell configuration, the processor 303 performs one or more of following operations: autonomously performing the MR-DC release upon the trigger of the MCG LTM, determining a secondary cell group (SCG) to be deactivated upon the trigger of the MCG LTM, or canceling a triggered LTM upon the trigger of the MCG LTM. In some embodiments, at least one LTM candidate configuration includes one or more of configurations: a cell group index associated with each LTM candidate, a SCG configuration associated with the cell group index, or a list of LTM candidate configurations including at least one reference configuration.

In some embodiments, determining whether or not to perform the MR-DC release or the MR-DC setup upon the trigger of the MCG LTM includes one or more of following operations: if there is no SCG configuration associated with the cell group index of a target cell, the UE 10 performs the MR-DC release when the UE 10 is in an MR-DC mode, if there is an SCG configuration associated with the cell group index of the target cell, the processor 303 applies the SCG configuration, or if the cell group index of a source cell and the target cell or a candidate cell are same, the processor 303 retains the SCG configuration and performs an MCG LTM execution. In some embodiments, the processor 303 performs the MR-DC release if the UE 10 is in the MR-DC mode before applying the SCG configuration.

In some embodiments, if there is no SCG configuration associated with the cell group index of the target cell, the processor 303 performs the MR-DC release when the UE 10 is in the MR-DC mode and cell group indexes of the source cell and target cell are different. In some embodiments, if there is the SCG configuration associated with the cell group index of the target cell, the UE applies the SCG configuration when the UE is in the MR-DC mode and cell group indexes of the source cell and target cell are different. In some embodiments, the MCG LTM is triggered by an LTM cell switch medium access control (MAC) control element (CE) received from a network or a fulfillment of execution conditions associated with an LTM candidate cell in a conditional LTM.

FIG. 6 is an example of a method 400 of managing cell group connectivity performed by a UE according to an embodiment of the present disclosure. The method 400 of managing cell group connectivity performed by a UE is configured to implement some embodiments of the disclosure. Some embodiments of the disclosure may be implemented into the method 400 of managing cell group connectivity performed by a UE using any suitably configured hardware and/or software. In some embodiments, the method 400 of managing cell group connectivity performed by a UE includes: an operation 402, determining to perform a multi-radio dual connectivity (MR-DC) release upon a trigger of a master cell group (MCG) lower-layer triggered mobility (LTM). This can solve issues in the prior art and other issues, manage cell group connectivity, and/or avoid a service interruption.

In some embodiments, determining to perform the MR-DC release upon the trigger of the MCG LTM includes one or more of following operations: performing the MR-DC release upon the trigger of the MCG LTM based on a release indication, determining whether or not to perform the MR-DC release upon the trigger of the MCG LTM based on an indication included in an LTM cell switch command, determining whether or not to perform the MR-DC release or an MR-DC setup upon the trigger of the MCG LTM based on a cell group index and/or an availability of a secondary cell group (SCG) configuration, or autonomously performing the MR-DC release upon the trigger of the MCG LTM. In some embodiments, the release indication is included in an LTM candidate configuration.

In some embodiments, if the UE is not in an MR-DC mode or the UE has an MCG configuration without any associated secondary cell group (SCG) configuration, the release indication is ignored by the UE. In some embodiments, the cell group index is associated with a source cell and a target cell, and/or the availability of the SCG configuration associated with the target cell. In some embodiments, if the UE is in an MR-DC mode, and the release indication is not included in a target cell configuration, the UE performs one or more of following operations: autonomously performing the MR-DC release upon the trigger of the MCG LTM, determining a secondary cell group (SCG) to be deactivated upon the trigger of the MCG LTM, or canceling a triggered LTM upon the trigger of the MCG LTM. In some embodiments, at least one LTM candidate configuration includes one or more of configurations: a cell group index associated with each LTM candidate, a SCG configuration associated with the cell group index, or a list of LTM candidate configurations including at least one reference configuration.

In some embodiments, determining whether or not to perform the MR-DC release or the MR-DC setup upon the trigger of the MCG LTM includes one or more of following operations: if there is no SCG configuration associated with the cell group index of a target cell, the UE performs the MR-DC release when the UE is in an MR-DC mode, if there is an SCG configuration associated with the cell group index of the target cell, the UE applies the SCG configuration, or if the cell group index of a source cell and the target cell or a candidate cell are same, the UE retains the SCG configuration and performs an MCG LTM execution. In some embodiments, the UE performs the MR-DC release if the UE is in the MR-DC mode before applying the SCG configuration.

In some embodiments, if there is no SCG configuration associated with the cell group index of the target cell, the UE performs the MR-DC release when the UE is in the MR-DC mode and cell group indexes of the source cell and target cell are different. In some embodiments, if there is the SCG configuration associated with the cell group index of the target cell, the UE applies the SCG configuration when the UE is in the MR-DC mode and cell group indexes of the source cell and target cell are different. In some embodiments, the MCG LTM is triggered by an LTM cell switch medium access control (MAC) control element (CE) received from a network or a fulfillment of execution conditions associated with an LTM candidate cell in a conditional LTM.

### Exemplary Technical Solutions:

In some embodiments, a UE performs one or more of the following operations during an MCG LTM execution: a. Executes an MR-DC release based on an explicit indication included in the candidate configuration. If the UE is not in MR-DC mode, the UE ignores the indication. b. Determines whether to perform an MR-DC release based on the indication in the LTM cell switch command MAC CE. c. Determines whether to perform an MR-DC release or setup based on the cell group index and/or the availability of an SCG configuration associated with the cell group index. d. Autonomously releases MR-DC upon MCG LTM execution.

In some embodiments, if a user equipment (UE) is in multi-radio dual connectivity (MR-DC) mode upon the trigger of master cell group (MCG) lower-layer triggered mobility (LTM), the UE performs one or more of the following operations: a) Executes MR-DC release according to a release indication. If the UE is not in MR-DC mode or has only an MCG configuration, it ignores the indication. b) Determines whether to perform MR-DC release based on the indication included in the LTM cell switch command. c) Determines whether to perform MR-DC release or setup based on the cell group index associated with the source and target cells and/or the availability of an SCG configuration associated with the target cell. d) Performs MR-DC release without following any explicit indication.

In some embodiments, for operation a), if the UE is in MR-DC mode but the release indication is not included in the target cell configuration, the UE performs one or more the following operations upon the trigger of MCG LTM: 1. Executes MR-DC release without following any explicit indication. 2. Considers the SCG to be deactivated. 3. Cancels the triggered LTM. 4. The LTM candidate configurations may include: a cell group index associated with each LTM candidate (e.g., candidate cells associated with the same cell group index), a SCG configuration associated with the cell group index, and/or a list of LTM candidate configurations, including reference configurations.

In some embodiments, the UE determines whether to perform SCG release/setup during MCG LTM execution according to one or more of the following: 1) If there is no SCG configuration associated with the cell group index of the target cell, the UE performs MR-DC release (if the UE is in DC mode). 2) If there is an SCG configuration associated with the cell group index of the target cell, the UE applies the corresponding SCG configuration. Optionally, the UE first performs MR-DC release (if the UE is in DC mode) before applying the SCG configuration. 3) Optionally, the UE performs either operation 1) or operation 2) only when the cell group indexes of the source and target cells are different. 4) If the cell group index of the serving cell is the same as the target or candidate cell, the UE retains the current SCG configuration and executes MCG LTM.

In some embodiments, the MCG LTM can be triggered either by an LTM cell switch medium access control (MAC) control element (CE) received from the network (NW) or by the fulfillment of the execution conditions associated with an LTM candidate cell (conditional LTM). The proposed solution can provide a clear approach for managing MR-DC configuration during MCG LTM execution.

In summary, the proposed solution outlines a clear approach for managing multi-radio dual connectivity (MR-DC) configuration during master cell group (MCG) lower-layer triggered mobility (LTM) execution. In various embodiments, a user equipment (UE) performs different operations based on specific conditions and indications. During MCG LTM execution, the UE may execute an MR-DC release based on an explicit indication in the candidate configuration or autonomously if no indication is present. The UE can also make decisions about MR-DC release or setup by evaluating the cell group index and the availability of a secondary cell group (SCG) configuration. If the UE is in MR-DC mode and the release indication is missing in the target cell configuration, it may perform an MR-DC release autonomously, consider the SCG deactivated, and cancel the LTM. Additionally, the LTM candidate configurations can include a cell group index, an SCG configuration, or a list of candidate configurations to guide these decisions. Furthermore, the UE can determine SCG release or setup during MCG LTM based on conditions such as the presence or absence of an SCG configuration, the cell group index of the target cell, and whether the indexes of the source and target cells differ. MCG LTM can be triggered by an LTM cell switch MAC control element received from the network or by conditions associated with an LTM candidate cell. This approach offers a structured and adaptable solution for effectively managing MR-DC configurations during LTM process.

Commercial interests for some embodiments are as follows. 1. Solve issues in the prior art and other issues. 2. Manage cell group connectivity. 3. Avoid a service interruption. 4. Maintain service continuity. 5. Provide a good communication performance. 6. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

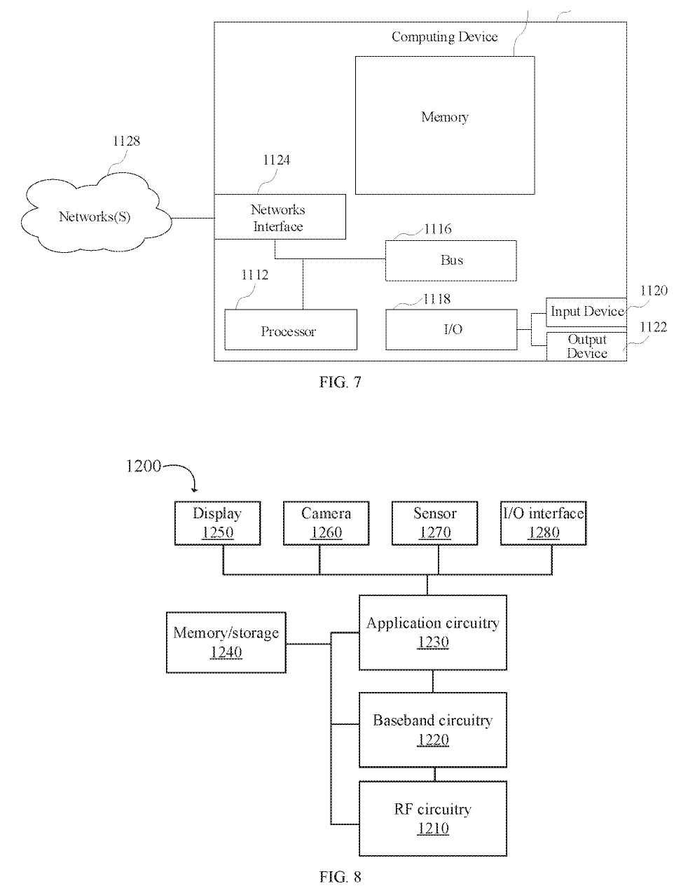

FIG. 7 is an example of a computing device 1100 according to an embodiment of the present disclosure. Any suitable computing device can be used for performing the operations described herein. For example, FIG. 7 illustrates an example of the computing device 1100 that can implement some embodiments of FIG. 1 to FIG. 6 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 6. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 8 is a block diagram of an example of a communication system 1200 according to an embodiment of the present disclosure. Embodiments described herein may be implemented into the communication system 1200 using any suitably configured hardware and/or software. FIG. 8 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 6. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 6 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the operations disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of managing cell group connectivity performed by a user equipment (UE), comprising:
determining to perform a multi-radio dual connectivity (MR-DC) release upon a trigger of a master cell group (MCG) lower-layer triggered mobility (LTM).

2. The method of claim 1, wherein determining to perform the MR-DC release upon the trigger of the MCG LTM comprises one or more of following operations:
performing the MR-DC release upon the trigger of the MCG LTM based on a release indication;
determining whether or not to perform the MR-DC release upon the trigger of the MCG LTM based on an indication included in an LTM cell switch command;
determining whether or not to perform the MR-DC release or an MR-DC setup upon the trigger of the MCG LTM based on a cell group index and/or an availability of a secondary cell group (SCG) configuration; or
autonomously performing the MR-DC release upon the trigger of the MCG LTM.

3. The method of claim 2, wherein the release indication is included in an LTM candidate configuration.

4. The method of claim 2, wherein if the UE is not in an MR-DC mode or the UE has an MCG configuration without any associated secondary cell group (SCG) configuration, the release indication is ignored by the UE.

5. The method of claim 2, wherein the cell group index is associated with a source cell and a target cell, and/or the availability of the SCG configuration associated with the target cell.

6. The method of claim 2, wherein if the UE is in an MR-DC mode, and the release indication is not included in a target cell configuration, the UE performs one or more of following operations:
autonomously performing the MR-DC release upon the trigger of the MCG LTM;
determining a secondary cell group (SCG) to be deactivated upon the trigger of the MCG LTM; or
canceling a triggered LTM upon the trigger of the MCG LTM.

7. The method of claim 3, wherein at least one LTM candidate configuration comprises one or more of configurations:
a cell group index associated with each LTM candidate;
a SCG configuration associated with the cell group index; or
a list of LTM candidate configurations including at least one reference configuration.

8. The method of claim 2, wherein determining whether or not to perform the MR-DC release or the MR-DC setup upon the trigger of the MCG LTM comprises one or more of following operations:
if there is no SCG configuration associated with the cell group index of a target cell, the UE performs the MR-DC release when the UE is in an MR-DC mode;
if there is an SCG configuration associated with the cell group index of the target cell, the UE applies the SCG configuration; or
if the cell group index of a source cell and the target cell or a candidate cell are same, the UE retains the SCG configuration and performs an MCG LTM execution.

9. The method of claim 8, wherein the UE performs the MR-DC release if the UE is in the MR-DC mode before applying the SCG configuration.

10. The method of claim 2, wherein the MCG LTM is triggered by an LTM cell switch medium access control (MAC) control element (CE) received from a network or a fulfillment of execution conditions associated with an LTM candidate cell in a conditional LTM.

11. A user equipment (UE), comprising:
a memory storing a computer program; and
a processor coupled to the memory,
wherein when executed by the processor, the computer program causes the UE to determine to perform a multi-radio dual connectivity (MR-DC) release upon a trigger of a master cell group (MCG) lower-layer triggered mobility (LTM).

12. The UE of claim 11, wherein determining to perform the MR-DC release upon the trigger of the MCG LTM comprises one or more of following operations:
performing the MR-DC release upon the trigger of the MCG LTM based on a release indication;
determining whether or not to perform the MR-DC release upon the trigger of the MCG LTM based on an indication included in an LTM cell switch command;
determining whether or not to perform the MR-DC release or an MR-DC setup upon the trigger of the MCG LTM based on a cell group index and/or an availability of a secondary cell group (SCG) configuration; or
autonomously performing the MR-DC release upon the trigger of the MCG LTM.

13. The UE of claim 12, wherein the release indication is included in an LTM candidate configuration.

14. The UE of claim 12, wherein if the UE is not in an MR-DC mode or the UE has an MCG configuration without any associated secondary cell group (SCG) configuration, the release indication is ignored by the UE.

15. The UE of claim 12, wherein the cell group index is associated with a source cell and a target cell, and/or the availability of the SCG configuration associated with the target cell.

16. The UE of claim 12, wherein if the UE is in an MR-DC mode, and the release indication is not included in a target cell configuration, the UE performs one or more of following operations:
autonomously performing the MR-DC release upon the trigger of the MCG LTM;
determining a secondary cell group (SCG) to be deactivated upon the trigger of the MCG LTM; or
canceling a triggered LTM upon the trigger of the MCG LTM.

17. The UE of claim 12, wherein determining whether or not to perform the MR-DC release or the MR-DC setup upon the trigger of the MCG LTM comprises one or more of following operations:
if there is no SCG configuration associated with the cell group index of a target cell, the UE performs the MR-DC release when the UE is in an MR-DC mode;
if there is an SCG configuration associated with the cell group index of the target cell, the UE applies the SCG configuration; or
if the cell group index of a source cell and the target cell or a candidate cell are same, the UE retains the SCG configuration and performs an MCG LTM execution.

18. The UE of claim 17, wherein if there is no SCG configuration associated with the cell group index of the target cell, the UE performs the MR-DC release when the UE is in the MR-DC mode and cell group indexes of the source cell and target cell are different.

19. The UE of claim 17, wherein if there is the SCG configuration associated with the cell group index of the target cell, the UE applies the SCG configuration when the UE is in the MR-DC mode and cell group indexes of the source cell and target cell are different.

20. A chip, including:
a processor, configured to call and run a computer program stored in a memory, to cause a device in which the chip is installed to:
determine to perform a multi-radio dual connectivity (MR-DC) release upon a trigger of a master cell group (MCG) lower-layer triggered mobility (LTM).
